(19) United States
(12) Patent Application Publication
(10) Pub. No.: US 2016/0217405 A1
(43) Pub. Date: Jul. 28, 2016

(54) Change Requests

(71) Applicants: Jochen Steinbach, Bad Schoenborn (DE); Thomas Friedrich, Walldorf (DE); Albin Brotz, Ravensburg (DE); Ralph Merkle, Salem (DE); Vladimir Shapiro, Sinsheim (DE); Jutta Butzin, Heidelberg (DE)

(72) Inventors: Jochen Steinbach, Bad Schoenborn (DE); Thomas Friedrich, Walldorf (DE); Albin Brotz, Ravensburg (DE); Ralph Merkle, Salem (DE); Vladimir Shapiro, Sinsheim (DE); Jutta Butzin, Heidelberg (DE)

(21) Appl. No.: 14/607,773

(22) Filed: Jan. 28, 2015

(51) Int. Cl. G06Q 10/06; G06F 17/30

(52) U.S. Cl. CPC G06Q 10/06315; G06F 17/30377; G06F 17/30371

(57) ABSTRACT

A method, a system and a computer program product for generating a change request object to and associating the generated object with an existing business object are disclosed. A desired update to a first business object is created. The first business object contains a plurality of attributes, where each attribute in the plurality of attributes has a value. Based on the created update, a second business object is generated. The second business object contains at least one change to a value of an attribute of the first business object and a copy of the value of the attribute of the first business object. The value of the attribute in the first business object is compared with a copy of the value of the attribute contained in the generated second business object. Based on the comparison, the second business object is associated with the first business object.

### TECHNICAL FIELD

This disclosure relates generally to data processing and, in particular, to generating of change request objects in material requirements planning and/or supply chain management planning system and associating such change requests with other objects in the system.

### BACKGROUND

In today's world, many companies rely on software applications to conduct their business. Software applications deal with various aspects of companies' businesses, which can include finances, product development, human resources, customer service, management, and many other aspects. Software applications typically operate from servers and can be stored in memory. To use software applications, users typically employ various computing devices. User interfaces provide users with an ability to provide instructions to software applications, interact with other users, and perform various functionalities in furthering their company's business.

Companies implement software application to perform materials requirements planning (“MRP”) and/or supply chain management (“SCM”) planning MRP systems can be used to perform production planning, scheduling, and/or inventory control that can be used to manage manufacturing processes. An MRP system can simultaneously perform the following: ensure that materials are available for production and/or products are available for delivery to customers, maintain the lowest possible material and/or product levels in store, and/or plan manufacturing activities, delivery schedules and/or purchasing activities. SCM refers to design, planning, execution, control, and/or monitoring of supply chain activities with the objective of creating net value, building a competitive infrastructure, leveraging worldwide logistics, synchronizing supply with demand and/or measuring performance globally. SCM can further include planning and management of activities involved in sourcing, procurement, conversion, and/or logistics management as well as coordination and collaboration with channel partners, which can include suppliers, intermediaries, third-party service providers, and/or customers. SCM can integrate supply and demand management within and across companies.

Typically, MRP and/or SCM Planning systems automatically react to changes in a planning situation (for example, changes in demands and/or supplies), however, in some cases, especially in a short-term horizon, adjustments to a particular plan can only be performed after an agreement and/or consultation with other involved parties. These coordination processes can be time consuming and while they are ongoing, they can cause inconsistencies and/or uncertainties in the plan. Thus, there is a need for an efficient system that can manage requested changes as long as they are tentative, without causing substantial disruptions to the MRP and/or SCM planning systems. This system can accommodate MRP and/or SCM planning systems of parties receiving a change request. Thus, as long as there is no final decision on a change request, MRP and/or SCM planning and/or analysis can be used to reflect requested adjustments and/or their effects prior to implementing the requested change.

### SUMMARY

In some implementations, the current subject matter relates to a computer-implemented method for generating a change request object to and associating the generated object with an existing business object in a system. The method can include creating a desired update to a first business object, the first business object containing a plurality of attributes, each attribute in the plurality of attributes having a value; generating, based on the created update, a second business object, the second business object containing at least one change to a value of at least one attribute in the plurality of attributes of the first business object and a copy of the value of the at least one attribute of the first business object; comparing the value of the at least one attribute in the first business object with a copy of the value of the at least one attribute contained in the generated second business object; and associating, based on the comparing, the second business object and the first business object. At least one of the creating, the generating, the comparing, and the associating can be performed by at least one processor of at least one computing system.

In some implementations, the current subject matter can include one or more of the following optional features. Each attribute in the second business object can be associated with at least one of the following values: an original value contained in the first business object, a changed value, and a proposed value. The changed value can represent a requested value of the attribute in the first business object. The proposed value can represent another value of the attribute in the first business object after application of another desired change (e.g., a counterproposal received from a supplier of items identified in the purchase order).

In some implementations, comparison operation can include determining that the value of the attribute in the first business object is different from the copy of the value of the attribute contained in the second business object and performing at least one of the following: deleting the second business object, updating the second business object, and not updating the second business object. This can, for example, prevent use of change requests that are based on outdated and/or deleted business objects.

The first business object and/or the second business object can include at least one of the following: a purchase order, a sales order, and a production order in at least one of the following: materials requirements planning and supply chain management planning.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for generating change requests, according to some implementations of the current subject matter;

FIG. 2 illustrates an exemplary process for generating a change request in a planning system, according to some implementations of the current subject matter;

FIG. 3 illustrates an exemplary system for generating a change request object to be associated with an underlying business object, according to some implementations of the current subject matter;

FIG. 4 illustrates an exemplary system for applying a generated change request business object to an underlying business object, according to some implementations of the current subject matter;

FIG. 5 illustrates an exemplary system for coordinating association of a change request to an underlying business objection, according to some implementations of the current subject matter;

FIG. 6 is an exemplary system, according to some implementations of the current subject matter; and

FIG. 7 is an exemplary method, according to some implementations of the current subject matter.

### DETAILED DESCRIPTION

To address these and potentially other deficiencies of currently available solutions, one or more implementations of the current subject matter provide methods, systems, articles or manufacture, and the like that can, among other possible advantages, provide for generating of change request objects and associating such change requests with other objects in a material requirements planning and/or supply chain management planning systems.

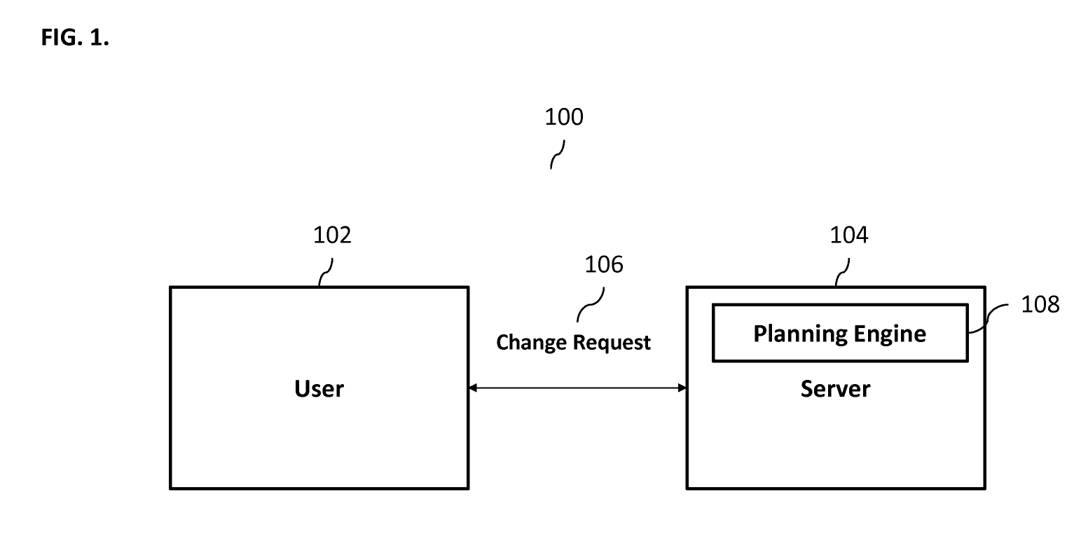

FIG. 1 illustrates an exemplary system 100 for generating change requests, according to some implementations of the current subject matter. The system 100 can include a user 102 and a server 104 that can be communicatively coupled to one another. The user can be an individual, a company, a software application, a business object, a business process, a business process application, and/or any other entity. The server 104 can be part of a company system, which can include a material requirements planning and/or supply chain management planning system(s). Such systems can assist a company in planning of production, sales, distribution, management, and/or any other aspects of its business.

The user 102 can communicate with the server 104 to access various applications, data, etc., which can include business objects, business processes, business process applications, etc. The server 104 can also store information about such business objects, business processes, business process applications, etc. and can provide the information to the user 102 upon an appropriate request. The business objects, business processes, business process applications, etc. (collectively referred to as “objects” or “business objects” or “underlying business objects”) can be created by various users of the company's computing system. Some examples of such business objects can include sales orders, purchase orders, production orders, etc. The business objects can include a plurality of attributes that identify and/or define information contained in the business object. In the example of a purchase order, its attributes can include at least one of the following: a quantity of items being ordered, a price of each item, order date, delivery date (e.g., a requested delivery date), as well as any other information. Once the purchase order is entered into the company's system, company's employees (such as those with appropriate access rights) are able to view it, its status, and/or any other information associated with the order. In some implementations, company's system can include a mechanism that can perform consideration of the various business objects existing in the system to determine their current status, ascertain whether there are any updates, as well as perform any other management functions.

In some implementations, user 102 can also submit generate various change requests to existing business objects in the system. The change requests can also relate to changes to attributes of the business objects. In some implementations, change requests can be implemented as part of the material requirements planning and/or supply chain management planning. For example, in case of a purchase order calling for a purchase/delivery of one hundred items of a specific material, a change can relate to an increase in the number of items to two hundred, and/or to a different delivery date, and/or to any other change. The change requests can be submitted at any time. They can be generated manually and/or automatically upon receipt of information relating to an attribute of an existing business object (e.g., a purchase order) that may require a change to the attribute.

In some implementation, the change request can be generated as a business object and can be associated with the existing and/or underlying business object in the company system. Further, one or more change request objects can be representative of multiple changes. Once the change request business object(s) are associated with the existing business object in the system, users accessing company's system can view the original business object and any of its associated change request business object(s). This way any user accessing the system can be alerted to the existence of any change. This can provide an important notification mechanism to various departments (e.g., purchasing, production, sales, distribution, etc.) within the company about status of various purchase orders, production orders, sales orders, etc. A user interface can be used to view the original business object and any other objects (including change request objects) associated with it.

In some implementations, the change request objects may or may not be implemented in the system, i.e., an original business object and its associated change request objects can exist in the system, where the changes have not yet been confirmed. For example, in case of a purchase order, a supplier of the requested items might not have confirmed its ability to deliver an increased quantity of the requested items by a specific date; however, once the change request object has been associated with the original purchase order, users viewing the purchase order are able to view the change request that has been created. Further, the supplier of the requested items can also provide a counterproposal, e.g., delivery of fewer than the increased quantity of items on the requested dated. The counterproposal information can also be viewed by the users accessing the original purchase order.

Referring back to FIG. 1, the server 104 can also include a planning engine 108. The planning engine 108 can be software, hardware, and/or any combination thereof. The engine 108 can be used to perform various calculations to correlate the original business objects and generated change requests that may be submitted by the user 102. The planning engine 108 can determine whether the change request object is based on the up-to-date original business object or whether it is based on an outdated original business object. This can be important in the situations where changes have been made to the original business object after the change request object has been created (e.g., the original purchase order has been cancelled).

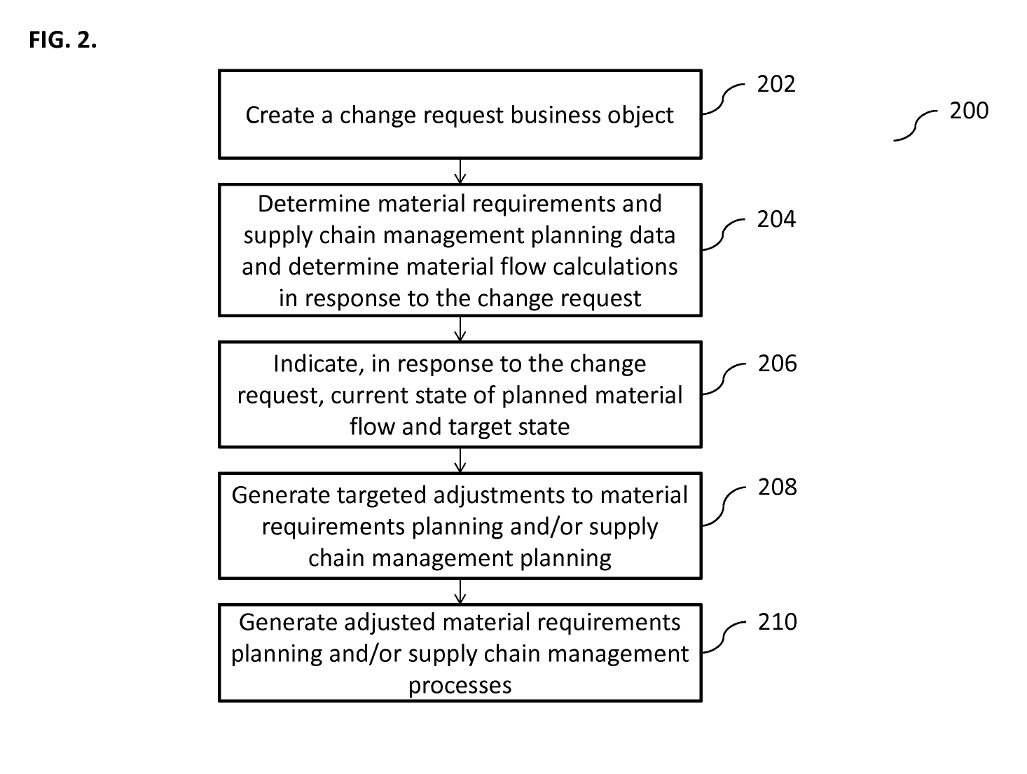

FIG. 2 illustrates an exemplary process 200 for generating a change request in a planning system, according to some implementations of the current subject matter. The planning system can include material requirements planning and/or supply chain management planning systems. At 202, a change request business object can be created or received in the company system. This can be accomplished automatically and/or manually by the user 102 (shown in FIG. 1) submitting a change request to one or more business objects in the material requirements planning and/or supply chain management systems. The change request object can include changes to one or more attributes of such one or more business objects in the system. The change request business object can be reflective of at least one planned and/or unplanned adjustment to existing business objects (e.g., an urgent request for a purchase of additional production materials).

At 204, material requirements and/or supply chain management planning data can be determined. Further, based on the change request business object, material flow calculations responsive to the change request can be ascertained. This can involve a determination of whether or not the received change request may affect a particular business object, business process, business process application, etc. as well as what changes may need to be implemented as a result of the change request. This determination can be performed by the planning engine 108 (shown in FIG. 1). For example, if the change request affects delivery quantity of a purchase order, the effect on the available stock quantity over time may need to be shown as a result of the change request (e.g., a change request indicative of a higher quantity of items may cause a material surplus) in addition to the quantity of the original purchase order.

At 206, a current state of planned material requirements and/or supply chain management flow may be indicated to the user 102 (shown in FIG. 1) in response to the change request. Such indication can be presented to the user 102 in a user interface and/or provided to the user in any other fashion. Further, a target state of the planned material requirements and/or supply chain management flow that is responsive to the change request can also be indicated to the user (e.g., presented in a user interface). For example, a change request to increase a number of items in a purchase order can indicate a price-per-item of X that corresponds to a price per item prior to the change request and a price-per-item of Y that corresponds to a price per item after implementing the change request (where Y<X). In some implementations, the indication of current and target states can be reflective of changes that have not yet been actually implemented and/or the changes that have been implemented.

At 208, targeted adjustments to material requirements planning and/or supply chain management planning can be generated. The changes can be communicated to the MRP and/or SCM process counterparts. For example, in case of a purchase order above, the counterparts can be suppliers of items contained in the purchase order. The suppliers can also provide an appropriate reply that may be responsive to the requested changes.

At 210, once the change request has been implemented, adjusted material requirements planning and/or supply chain management processes can be generated. These can also include lifecycle of the change process in the system and can be transparent to the user and/or user's counterpart at any time. Once the change requests objects and/or any counterproposal are submitted to the company system, the users accessing the system and in particular the purchase order in question, can view the original purchase order object, the submitted change request, and/or any counterproposal. The users can also be provided with a status of the changes to the purchase order and/or any other information that may assist users in decision-making processes. The user interfaces can also indicate to the user best case scenarios (e.g., submitted change requests are implemented), current status, a worst case scenario (e.g., submitted change request cannot be implemented), alternative case scenarios (e.g., some, but not all, submitted change requests can be implemented), as well as any other scenarios. These scenarios can be determined by the planning engine 108 (shown in FIG. 1).

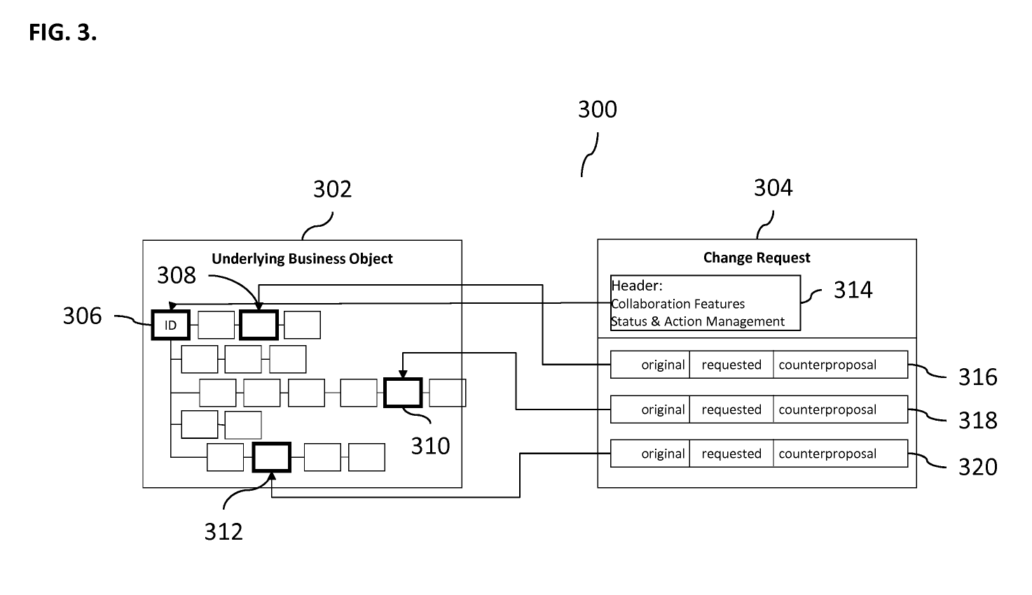

FIG. 3 illustrates an exemplary system 300 for generating a change request object to be associated with an underlying business object, according to some implementations of the current subject matter. The system 300 can include an underlying or an original business object 302 and a change request object 304 for association with the business object 302. In some implementations, the change request 304 can be a business object. The business object 302 can be any business object, business process, business process application, etc. The business object 302 can include an identifier 306 that can be used to identify the business object 302 to other business objects, business processes, business process applications, etc. The business object 302 can also include various attributes 308, 310, 312. The attributes can be specific to the particular business object. For example, in case of a purchase order, these can include price, number of items being ordered, etc. As shown in FIG. 3, attributes can be dependent on one another, such as in a hierarchical data model. Each attribute can be associated with a particular metadata that can be used to identify the attribute and/or its features. The attributes along with their corresponding metadata can be stored in a memory location.

In some implementations, the change request business object 304 can include a header 314 that can include collaboration features (e.g., generating and/or receiving emails, messages and the like, adding notes, etc.) as well as status and action management. The status and action management can relate to status information of the change being requested. For example, in case of a purchase order, the status can indicate that requested change has been submitted to a supplier, who presented a counterproposal. When creating a change request object, relevant attributes and their values of the underlying business object can be copied into an instance of the change request. These can be indicated in the change request object as “original”, as shown in FIG. 3. The change request header 314 can refer to the header and/or identifier 306 of the underlying business object 302.

The change request business object 304 can further include attributes 316, 318, 320 that can be copied from the underlying business object 302 and correspond to the attributes of the business object 302. Thus, the attribute 316 of the change request 304 can correspond to the attribute 308 of the business object 302; the attribute 318 can correspond to the attribute 310; and the attribute 320 can correspond to the attribute 312.

In some implementations, each attribute 316, 318, 320 of the change request business object 304 can include at least one of the following fields: an “original” value field, a “requested” value field, and/or a “counterproposal” value field, as shown in FIG. 3. The original value field can include a value of the attribute as it existed when the change request was created. This can be the original value of the corresponding attribute in the business object 302. The requested value field can include a desired or a requested value of the attribute. The desired value of the attribute can be indicated by the user and/or by the system (such as, in case change request is automatically created) when creating and/or submitting the change request. For example, the original value of the attribute corresponding to a number of items in a purchase order can be “X” and the requested value, as selected by the user and/or system, can be “2X”. The counterproposal value field can include values of the corresponding attribute when a counterproposal is received from a counterpart. For example, in the above purchase order, a supplier (i.e., a counterpart) can propose a value of “2.5X” for the number of items in response to receiving the change request from the user.

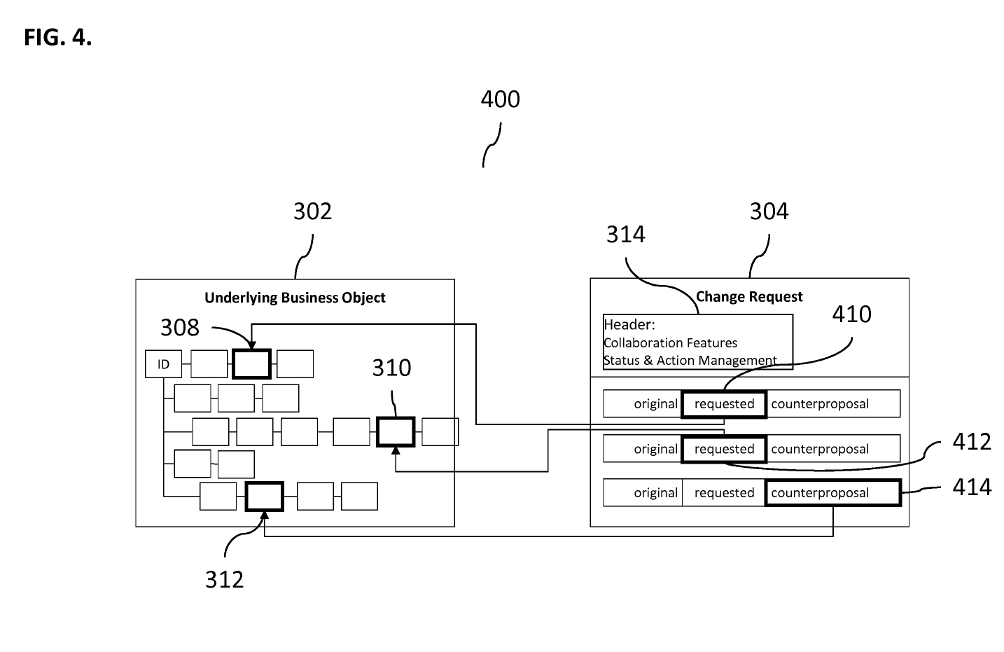

FIG. 4 illustrates an exemplary system 400 for applying the generated change request business object 304 to the underlying business object 302, according to some implementations of the current subject matter. When the change request business object 304 is eventually confirmed and applied, the values of attributes of the underlying business object 302 can be updated using attribute values contained in the change request 304. The update to the attributes of the underlying business object 302 can be performed using various standard processes, interfaces, methods, etc. of the underlying business object 302.

As shown in FIG. 4, the attribute 308 of the underlying business object 302 can be associated with the “requested” value 410 of the corresponding attribute in the change request 304. This means that a user accessing a user interface showing the business object 302 can be provided with an indication of the original value (as in the original business object 302) and the “requested” value 410 that was, for example, requested by the user 102 as part of the generated change request. The attribute 310 can similarly indicate the “requested” value 412 of the corresponding attribute in the change request 304. However, the attribute 312 of the business object 302 can indicate a “counterproposal” value 414 of the change request business object 304. Thus, the values of attributes 410, 412, 414 of the change request business object 304 can be shown to users accessing the business object 302 along with original values of attributes 308, 310, 312, respectively. This way, users are provided with a user interface that indicates all existing values that can be associated with a particular attribute of the original business object 302.

In some implementations, to determine whether the change request object 304 is based on the most current original business object 302, the current subject matter system can compare a current attribute value of the underlying business object 302 and the “original” attribute value contained in the change request 304. If there is a difference between two values, the change request may be outdated (e.g., the attribute value of the underlying business object has been changed since the change request has been created) and is likely no longer valid. This means that the values in the change request should no longer be indicated to the users and the change request object can be discarded. In alternative implementations, an appropriate warning message and/or indicator can be presented to the user that the values in the change request are no longer viable.

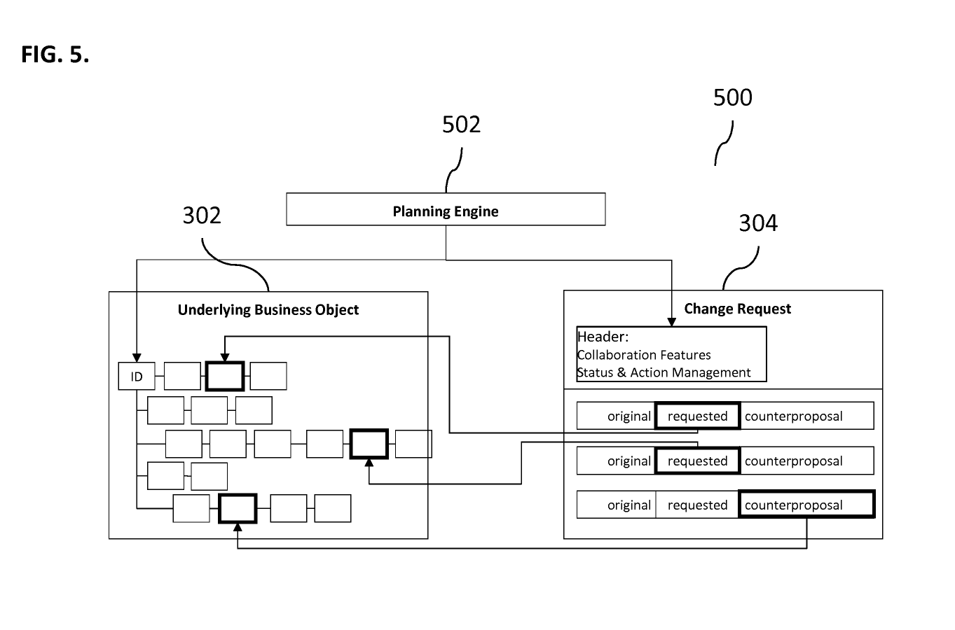

FIG. 5 illustrates an exemplary system 500 for coordinating association of a change request to an underlying business objection, according to some implementations of the current subject matter. The system 500 can include a planning engine 502 (similar to the planning engine 108 shown in FIG. 1) as well as other components that can be similar to the systems 300, 400 shown in FIGS. 3, 4, respectively. In some implementations, when the underlying business object 302 instance is read for planning purposes, the planning engine 502 (and/or any other procedure) can generate a query that can refer to any change requests associated with the identified instance of the underlying business object 302. If a change request is found, the planning engine 502 can then request and/or read appropriate planning data from the change request business object 304 and not from the business object 302. Depending on the status of the change request business object 304, the “requested” and/or “counterproposal” values can be determined by the planning engine 502. When the change request business object 304 is outdated, the planning engine 502 can ascertain the current value of the underlying business object 302. The planning engine 502 can perform various calculations to correlate attributes and/or its values the original business object 302 and attributes and/or values of the change request object(s) 304 that may have been created in the system.

In some implementations, the planning engine 502 can perform such calculations at any time, periodically, automatically (e.g., upon detection of change request object being created), and/or manually (e.g., upon receiving an instruction from the user). This can allow users accessing the system to receive most current status and/or any other information about a specific business object (e.g., a purchase order). This can substantially improve transparency as well as management and coordination among users within a company.

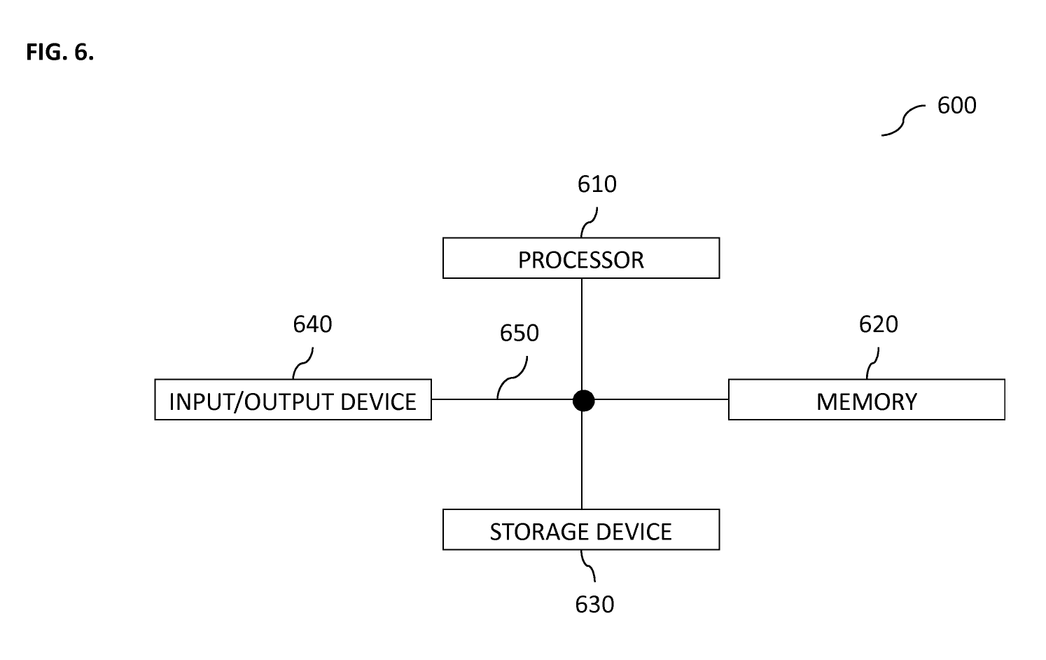

In some implementations, the current subject matter can be configured to be implemented in a system 600, as shown in FIG. 6. The system 600 can include a processor 610, a memory 620, a storage device 630, and an input/output device 640. Each of the components 610, 620, 630 and 640 can be interconnected using a system bus 650. The processor 610 can be configured to process instructions for execution within the system 600. In some implementations, the processor 610 can be a single-threaded processor. In alternate implementations, the processor 610 can be a multi-threaded processor. The processor 610 can be further configured to process instructions stored in the memory 620 or on the storage device 630, including receiving or sending information through the input/output device 640. The memory 620 can store information within the system 600. In some implementations, the memory 620 can be a computer-readable medium. In alternate implementations, the memory 620 can be a volatile memory unit. In yet some implementations, the memory 620 can be a non-volatile memory unit. The storage device 630 can be capable of providing mass storage for the system 600. In some implementations, the storage device 630 can be a computer-readable medium. In alternate implementations, the storage device 630 can be a floppy disk device, a hard disk device, an optical disk device, a tape device, non-volatile solid state memory, or any other type of storage device. The input/output device 640 can be configured to provide input/output operations for the system 600. In some implementations, the input/output device 640 can include a keyboard and/or pointing device. In alternate implementations, the input/output device 640 can include a display unit for displaying graphical user interfaces.

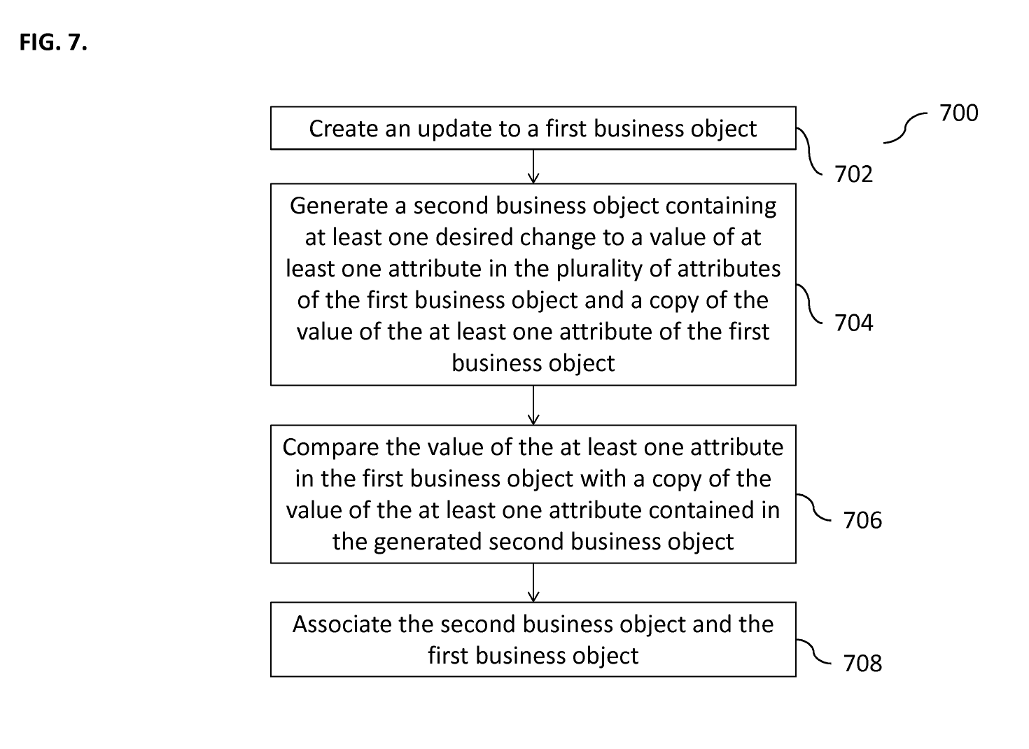

FIG. 7 illustrates an exemplary method 700 for generating a change request object to and associating the generated object with an existing business object in a system, according to some implementations of the current subject matter. At 702, an update can be created to a first business object. The update can be a desired change, a required change, and/or any other change to the first business object. This can be applicable to situations where a determination may need to be made as to how such change will affect the first business object and/or any other business object that may exist in the system and/or any system that may be associated therewith (e.g., a purchaser system, a supplier system, a production system, a sales system, etc.). The first business object can be an existing business object, such a purchase order, a production order, a sales order, etc. The first business object can contain a plurality of attributes, where each attribute can have a particular value. The attributes can be price, requested date of delivery of items, number of items, etc. In some example embodiments, a second business object (e.g., a change request) can be created for the purposes of potentially updating the first business object. An update can be performed to the first business object. Using the change request, it can be possible to evaluate (e.g., by comparing original attribute values of the first business object (which can be stored in the change request) with current attribute values of the first business object and determining, if and how the first business object was affected by the update contained in the change request). In some cases, the update can be so severe that the change request may become outdated. Alternatively, the change request may still be valid, but additional aspects may need to be considered, which can prompt the system to issue a warning to the user.

At 704, a second business object (e.g., a change request object) can be generated based on the created update to the first business object. The second business object can contain at least one desired change to a value of at least one attribute in the plurality of attributes of the first business object (e.g., quantity of items that can be different from the original purchase order) and a copy of the value of the attribute of the first business object (e.g., the quantity of items as requested in the original purchase order).

At 706, the value of the attribute in the first business object can be compared with a copy of the value of the attribute contained in the generated second business object. This operation can be performed to ensure that the change request business object is based on the most current original business object.

At 708, the second business object can be associated with the first business object. Such association can be performed by the planning engine 108 and/or any other component of the system 100 (shown in FIG. 1) and can allow users accessing information about the original business object (e.g., an original purchase order) to view information contained in the original object as well as any changes that may have been requested.

In some implementations, the current subject matter can include one or more of the following optional features. Each attribute in the second business object can be associated with at least one of the following values: an original value contained in the first business object, a changed value, and a proposed value. The changed value can represent a requested value of the attribute in the first business object. The proposed value can represent another value of the attribute in the first business object after application of another desired change (e.g., a counterproposal received from a supplier of items identified in the purchase order).

In some implementations, comparison operation can include determining that the value of the attribute in the first business object is different from the copy of the value of the attribute contained in the second business object and performing at least one of the following: deleting the second business object, updating the second business object, and not updating the second business object. This can, for example, prevent use of change requests that are based on outdated and/or deleted business objects.

The first business object and/or the second business object can include at least one of the following: a purchase order, a sales order, and a production order in at least one of the following: materials requirements planning and supply chain management planning.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
creating a desired update to a first business object, the first business object containing a plurality of attributes, each attribute in the plurality of attributes having a value;
generating, based on the created update, a second business object, the second business object containing at least one change to a value of at least one attribute in the plurality of attributes of the first business object and a copy of the value of the at least one attribute of the first business object;
comparing the value of the at least one attribute in the first business object with a copy of the value of the at least one attribute contained in the generated second business object; and
associating, based on the comparing, the second business object and the first business object;
wherein at least one of the creating, the generating, the comparing, and the associating is performed by at least one processor of at least one computing system.

2. The method according to claim 1, wherein each attribute in the second business object is associated with at least one of the following values: an original value contained in the first business object, a changed value, and a proposed value.

3. The method according to claim 2, wherein the changed value represents a requested value of the at least one attribute in the first business object.

4. The method according to claim 3, wherein the proposed value represents another value of the at least one attribute in the first business object after application of at least another desired change.

5. The method according to claim 1, wherein the comparing further comprises:
determining that the value of the at least one attribute in the first business object is different from the copy of the value of the at least one attribute contained in the second business object; and
performing at least one of the following: deleting the second business object, updating the second business object, and not updating the second business object.

6. The method according to claim 1, wherein the first business object and the second business object include at least one of the following: a purchase order, a sales order, and a production order in at least one of the following: materials requirements planning and supply chain management planning.

7. A system comprising:
at least one programmable processor; and
a machine-readable medium storing instructions that, when executed by the at least one programmable processor, cause the at least one programmable processor to perform operations comprising:
creating a desired update to a first business object, the first business object containing a plurality of attributes, each attribute in the plurality of attributes having a value;
generating, based on the created update, a second business object, the second business object containing at least one change to a value of at least one attribute in the plurality of attributes of the first business object and a copy of the value of the at least one attribute of the first business object;
comparing the value of the at least one attribute in the first business object with a copy of the value of the at least one attribute contained in the generated second business object; and
associating, based on the comparing, the second business object and the first business object.

8. The system according to claim 7, wherein each attribute in the second business object is associated with at least one of the following values: an original value contained in the first business object, a changed value, and a proposed value.

9. The system according to claim 8, wherein the changed value represents a requested value of the at least one attribute in the first business object.

10. The system according to claim 9, wherein the proposed value represents another value of the at least one attribute in the first business object after application of at least another desired change.

11. The system according to claim 7, wherein the comparing further comprises:
determining that the value of the at least one attribute in the first business object is different from the copy of the value of the at least one attribute contained in the second business object; and
performing at least one of the following: deleting the second business object, updating the second business object, and not updating the second business object.

12. The system according to claim 7, wherein the first business object and the second business object include at least one of the following: a purchase order, a sales order, and a production order in at least one of the following: materials requirements planning and supply chain management planning.

13. A computer program product comprising a machine-readable medium storing instructions that, when executed by at least one programmable processor, cause the at least one programmable processor to perform operations comprising:
creating a desired update to a first business object, the first business object containing a plurality of attributes, each attribute in the plurality of attributes having a value;
generating, based on the created update, a second business object, the second business object containing at least one change to a value of at least one attribute in the plurality of attributes of the first business object and a copy of the value of the at least one attribute of the first business object;
comparing the value of the at least one attribute in the first business object with a copy of the value of the at least one attribute contained in the generated second business object; and
associating, based on the comparing, the second business object and the first business object.

14. The computer program product according to claim 13, wherein each attribute in the second business object is associated with at least one of the following values: an original value contained in the first business object, a changed value, and a proposed value.

15. The computer program product according to claim 14, wherein the changed value represents a requested value of the at least one attribute in the first business object.

16. The computer program product according to claim 15, wherein the proposed value represents another value of the at least one attribute in the first business object after application of at least another desired change.

17. The computer program product according to claim 13, wherein the comparing further comprises:
determining that the value of the at least one attribute in the first business object is different from the copy of the value of the at least one attribute contained in the second business object; and
performing at least one of the following: deleting the second business object, updating the second business object, and not updating the second business object.

18. The computer program product according to claim 13, wherein the first business object and the second business object include at least one of the following: a purchase order, a sales order, and a production order in at least one of the following: materials requirements planning and supply chain management planning.
